(19) United States
(12) Patent Application Publication
(10) Pub. No.: US 2014/0247605 A1
(43) Pub. Date: Sep. 4, 2014

(54) METHOD FOR PRODUCING AN OPTICAL ELEMENT

(71) Applicants: Gertrud Kraeuter, Regensburg (DE); Ralph Wirth, Lappersdorf (DE)

(72) Inventors: Gertrud Kraeuter, Regensburg (DE); Ralph Wirth, Lappersdorf (DE)

(73) Assignee: OSRAM GMBH, Muenchen (DE)

(21) Appl. No.: 14/348,123

(22) PCT Filed: Aug. 23, 2012
(86) PCT No.: PCT/EP2012/066430

§ 371 Date: Mar. 28, 2014

(30) Foreign Application Priority Data
Oct. 12, 2011 (DE) 102011084316.7

(51) Int. Cl. C03C 4/12; F21V 8/00; F21V 5/04

(52) U.S. Cl. CPC C03C 4/12; F21V 5/04; G02B 6/0001
USPC 362/326; 65/17.2

(57) ABSTRACT

A method for producing an optical element made of quartz glass, said element being designed for a conversion of pump light, may include providing a sol having a silicon precursor, admixing the sol with at least one luminescent substance and one luminescent substance educt, gelling the sol to form a gel body, and sintering the gel body to form a quartz glass solid.

### TECHNICAL AREA

The present invention relates to a method for producing an optical element made of quartz glass, which is designed for a conversion of pump light.

### PRIOR ART

Light sources of high light density are used in greatly varying applications, in endoscopy and also in projection devices. The most recent developments relate to the combination of a pump light source of high power density, for example, a laser, with a luminescent substance element which converts pump light, and which is arranged spaced apart from the pump light source. A conversion of ultraviolet or blue pump light, for example, to converted light of longer wavelength is then performed by the luminescent substance element. The light emitted by LEDs is also converted by means of luminescent substance in many applications.

To produce a luminescent substance element, typically, luminescent substance particles are dispersed, for example, in water or an organic solvent, and this dispersion is then applied to a carrier. After evaporation of the solvent, a corresponding layer of luminescent substance particles remains.

The present invention is based on the technical problem of specifying an advantageous method for producing an optical element, which is designed for a conversion of pump light, made of quartz glass, and also a corresponding optical element, which is advantageous in relation to the prior art.

According to the invention, this problem is solved by a method having the following steps:
providing a sol having a silicon precursor;
admixing the sol with at least one luminescent substance and one luminescent substance educt;
gelling the sol to form a gel body;
sintering the gel body to form a quartz glass solid; and also a correspondingly reproduced quartz glass solid, in which luminescent substance is embedded.

The quartz glass solid is thus produced in a sol-gel method known per se (Ralph K. Iler; “The Chemistry of Silica: Solubility, Polymerization, Colloid and Surface Properties and Biochemistry of Silica: Solubility, Polymerization, Colloid and Surface Properties and Biochemistry”, John Wiley & Sons, New York 1979), in which the typically viscous liquid sol is admixed with luminescent substance or a luminescent substance educt (jointly referred to hereafter as a “luminescent substance” for the sake of simplicity if not specified to the contrary). The luminescent substance, which is provided, for example, in particle form having a mean particle size of several tens of nanometers up to several millimeters (typical values can be approximately between 1-30 μm), can be well dispersed in the sol and can be uniformly distributed in the scope of routine manufacturing variations. The sol thus includes a solvent, the luminescent substance dispersed therein, and a silicon precursor (an alcoholate of silicon), for example, tetramethyl orthosilicate (TMOS), tetraisopropyl orthosilicate (TPOT), or preferably tetraethyl orthosilicate (TEOS).

During the gelling, typically colloidal dissolved oligomers initially arise by way of hydrolysis and condensation of the silicon precursors, these oligomers then cross-linking to form three-dimensional polymer structures. A three-dimensional network is thus formed from the sol phase, in the pores of which the solvent and the luminescent substance particles, which were originally dispersed in the sol in the manner according to the invention, are contained. Also when the gelling has occurred, i.e., the network thus connects opposing external surfaces (typically delimited by a reaction vessel), the luminescent substance enclosed in the pores is uniformly distributed over the gel body, at least upon macroscopic observation, in any case perpendicularly to the direction of gravity.

This distribution of the luminescent substance over the pores of the gel body also remains when the gel body is subsequently sintered, whereby a quartz glass solid having luminescent substance particles embedded therein results.

Since in operation of a luminescent substance element, in the event of a conversion of higher-energy pump light into longer-wave light, a power loss emitted in the form of heat typically also occurs, for example, as a result of the Stoke shift, the heat conduction properties of the quartz glass and the embedding of the luminescent substance therein can particularly advantageously come to bear. Thus, specifically excess heating of the luminescent substance, which can result in an efficiency decrease of the light conversion, can be avoided. Furthermore, a luminescent substance distributed in the quartz glass can also be advantageous with respect to the optical properties, because thus, for example, undesired scattering effects on aggregated luminescent substance particles can be avoided.

Furthermore, by way of the embedding in quartz glass, for example, a reaction of the luminescent substance with atmospheric gases, for example, oxygen, or also with water or water vapor can also be avoided, the luminescent substance is thus protected. For example, if a red nitride-containing luminescent substance otherwise reacts with oxygen, this can result in an efficiency decrease during the light conversion as a result of a degradation of the luminescent substance, for example.

Preferred embodiments are specified in the dependent claims and will be explained hereafter, wherein the individual features can also be essential to the invention in different combinations and always implicitly relate to both the method for producing the optical element and also the optical element itself.

During the sintering, which is preferably performed over a duration of at least 24 hours, particularly preferably at least 36 hours, and during which a peak temperature of preferably at least 1000° C., particularly preferably at least 1300° C. is reached, the solvent is optionally also expelled from the pores depending on the preceding processing steps. However, this can also be performed in a separate processing step, which is explained hereafter. In any case, the gel body shrinks increasingly during sintering, preferably in this sequence by at least 10%, 20%, 30%, 40% and the density thereof increases accordingly. Silicon dioxide nanoparticles form; the quartz glass solid thus results.

In one preferred embodiment, luminescent substance educts are added to the sol, which then first react to form the actual luminescent substance under the high temperatures during the sintering. Thus, the gel body is compacted, on the one hand, and the luminescent substance is produced, on the other hand, using the sintering, which can also have economic advantages for reasons of processing economy.

Thus, for example, (yttrium oxide, aluminum oxide, and cerium oxide) and/or (barium nitride, strontium nitride, silicon nitride, and europium oxide) can be provided as luminescent substance educts, which then react accordingly to form YAG:Ce (yellow luminescent substance) and/or BaSrSiN:Eu (red luminescent substance).

In one preferred embodiment, the gel body is dried in a separate drying step before the sintering, and particularly preferably supercritically (in the meaning of the phase diagram). During the phase transition liquid/gaseous, i.e., the phase conversion also referred to as “vaporization”, specifically, the danger otherwise exists of destruction of finely-porous structures as a result of the capillary forces acting as a consequence of increasing surface tension. In particular, solvent which flows from the interior of the gel body as a consequence of the vaporization on the surface can result in a deformation of the three-dimensional gel network, up to the (partial) destruction thereof; a so-called xerogel can thus result.

The gel body is preferably thus dried in such a manner that the solvent is firstly shifted into the supercritical state and subsequently, at substantially uniform temperature, the pressure is reduced to the level of the ambient pressure. Since in this case, in contrast to subcritical drying, no phase boundary is exceeded (a differentiation between liquid/gaseous is not possible in the supercritical state), capillary forces which destroy the gel network also do not occur; it is substantially maintained, wherein the luminescent substance particles remain in the solvent-free pores. Since the external dimensions of the gel body are also substantially maintained with the three-dimensional network in the case of supercritical drying, a gel body of lower density results, i.e., having a density of less than 1 g/cm³, 0.5 g/cm³, or even 0.1 g/cm².

In a preferred embodiment, water is provided as the solvent of the sol, which is particularly preferably replaced by acetone before the drying. The supercritical drying is then performed at a temperature of at least 240° C., preferably at least 250° C., and at a pressure of at least 55 bar, preferably at least 60 bar. By exchanging the water with acetone, the critical temperature is decreased by approximately 140° C.

In a preferred embodiment, TEOS is provided as a silicon precursor in the particularly preferably aqueous solution. During the gelling, it is firstly converted in the course of the hydrolysis into monomer hydroxide compounds; these reactive monomers then bond in the course of the condensation with dehydration to form dimers, trimers, tetramers, and further oligomers, until the three-dimensional network structure finally arises with the formation of long-chain molecules.

Since after the gelling, but anyway in the case of an above-described supercritical drying of the gel body, the external dimensions of which still change to scale, surface ratios and, if present, edge ratios are substantially maintained, in a preferred embodiment, the shape of a cavity provided for accommodating the sol for the gelling at least corresponds in scale to those of the optical element. In consideration of the above-described shrinking, which occurs during sintering, the volume of the cavity is ideally selected to be correspondingly proportionally larger under the assumption of preferred isotropic shrinking. A post-treatment which is then used for the surface finishing of the optical element, for example, such as polishing, is therefore not considered to change the volume of the optical element; similarly, in a preferred embodiment, no such post-treatment is performed, also from method-economy considerations.

The correspondingly produced optical element can be designed both as imaging, for example, a lens, and also non-imaging, for example, for light guiding by total reflection on the outer walls; it can thus be designed, for example, as a so-called light guide, for example, in the form of a “compound parabolic concentrator” (CPC).

In the case of an above-described process having a drying step introduced upstream from the sintering, quartz glass solids having a transmission factor of greater than 90%, 95%, and even 99% may be achieved (with respect to a wavelength of 486 nm); the index of refraction is approximately 1.46, for example. As a result of the sintering, the gel body is compacted from the above-described gel body, which has lower density, in the course of the supercritical drying to form a quartz glass solid having a density of greater than 2 g/cm³, typically approximately 3.2 g/cm³.

### DESCRIPTION OF THE DRAWINGS

The invention will be explained in greater detail hereafter on the basis of exemplary embodiments, wherein the features can also be essential to the invention in another combination.

FIG. 1 shows the method according to the invention in an overview;

FIG. 2 schematically illustrates hydrolysis and condensation of the TEOS.

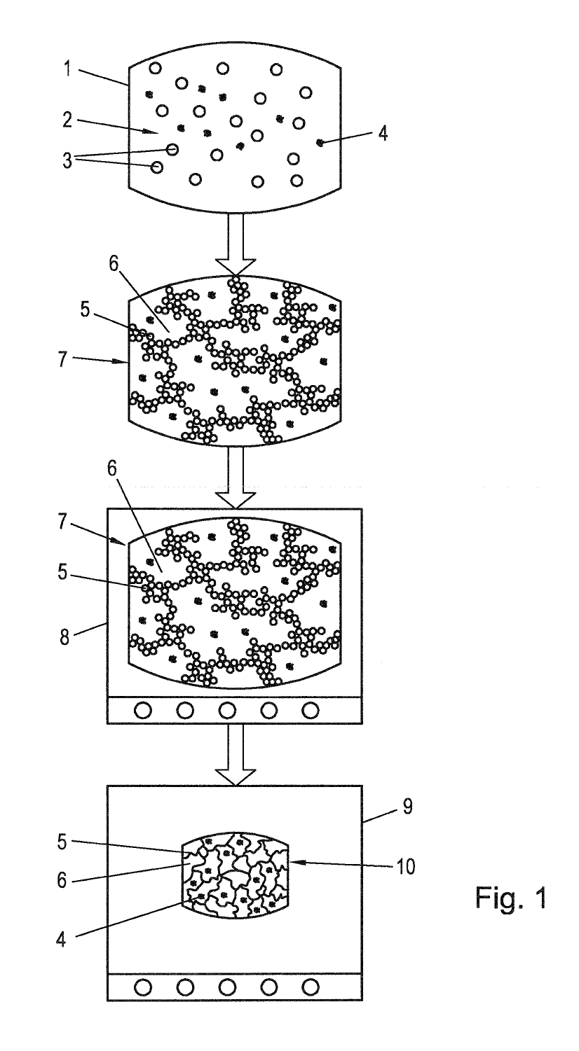

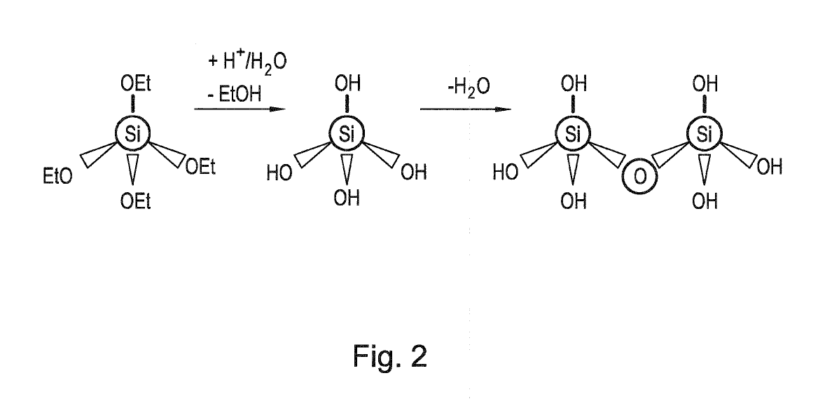

FIG. 1 shows the sol 2, which is provided in a cavity formed by a reaction vessel 1, having dispersed silicon precursors 3, specifically TEOS, and also having dispersed luminescent substance educts 4, in the present case yttrium oxide, aluminum oxide, and cerium oxide. As a result of the hydrolysis, reactive hydroxide groups form on the silicon, as is apparent from FIG. 2. These reactive hydroxide groups then react in the course of the condensation with dehydration, so that the silicon is connected via oxygen bridges to form chains, see also FIG. 2. For the formation of a three-dimensional network (in contrast to a condensation to form units which are highly cross-linked per se, but are not bonded), the provision of an acid milieu is decisive.

The chains, which become longer in the course of the gelling, thus form a three-dimensional network 5, which traverses the entire reaction vessel 1 in the gelled state, i.e., reaches from one vessel wall to the opposite one. In the pores 6 formed, the luminescent substance educts 4 added at the beginning to the sol 2 are distributed, and specifically with uniform density on average over the entire reaction vessel. A density gradient can also form along the direction of gravity as a result of sedimentation depending on the reaction speed, however. This can, on the one hand, optionally also result in a desired distribution of the luminescent substance for achieving specific optical effects; on the other hand, for example, if an optical element is to be produced, the conversion properties of which are essentially independent of an X/Y deflection of a pump light beam, the sol 2 can also be arranged during the gelling such that the direction of gravity is essentially parallel to the optical axis of the correspondingly produced optical element.

The gel body 7 is removed from the cavity after the gelling and placed in an acetone bath. The water in the pores of the gel body 7 is then thus replaced by acetone in a diffusion-driven manner, wherein the procedure can take a period of time from several days up to several weeks.

After the solvent exchange, the gel body 7 is placed in an autoclave 8 for drying; to avoid capillary forces which will possibly destroy the three-dimensional network, the drying is performed supercritically at a temperature of approximately 240° C. and a pressure of approximately 60 bar.

The gel body of low density thus obtained is subsequently sintered in a furnace 9, and specifically using an increasing temperature curve; the peak temperature reaches up to 1400° C. The gel body 7, which is initially still porous, shrinks in this case by approximately 50%, and does so in an isotropic manner. At the high temperatures occurring during sintering, the luminescent substance educts (yttrium oxide, aluminum oxide, cerium oxide) also react with one another, and a (YAG:Ce) luminescent substance results, which emits converted light in the yellow spectral range.

The resulting optical element 10 therefore corresponds in scale to the shape predefined for the sol or gel by the reaction vessel 1; in the present case, a collimating lens made of quartz glass having embedded luminescent substance particles was produced.

1. A method for producing an optical element made of quartz glass, said element being designed for a conversion of pump light, the method comprising:
providing a sol having a silicon precursor,
admixing the sol with at least one luminescent substance and one luminescent substance educt,
gelling the sol to form a gel body, and
sintering the gel body to form a quartz glass solid.

2. The method as claimed in claim 1, wherein the gel body is sintered over a duration of at least 24 hours and a peak temperature of at least 1000° C. is reached.

3. The method as claimed in claim 1, wherein a luminescent substance educt reacts during the sintering to form a luminescent substance.

4. The method as claimed in claim 3, wherein at least one of the group consisting of yttrium oxide, aluminum oxide, and cerium oxide, and the group consisting of barium nitride, strontium nitride, silicon nitride, and europium oxide is provided as the luminescent substance educt.

5. The method as claimed in claim 1, wherein the gel body is dried before the sintering.

6. The method as claimed in claim 5, wherein the drying is performed supercritically.

7. The method as claimed in claim 6, wherein, for the preparation of the supercritical drying, an exchange of solvent in the gel body occurs.

8. The method as claimed in claim 1, wherein tetraethoxy orthosilicate is provided as the silicon precursor.

9. The method as claimed in claim 1, wherein the gelling of the sol to form the gel is performed in a cavity, the shape of which corresponds at least in scale to that of the optical element.

10. An optical element made of quartz glass, which is designed for a conversion of pump light, produced in a sol-gel method as claimed such that luminescent substance is embedded in the quartz glass
the method comprising:
providing a sol having a silicon precursor,
admixing the sol with at least one luminescent substance and one luminescent substance educt,
gelling the sol to form a gel body, and
sintering the gel body to form a quartz glass solid.

11. The optical element as claimed in claim 10, which is designed as one of a lens and a non-imaging light guide.

12. The method as claimed in claim 5, wherein the drying is performed at a temperature of at least 240° C. and a pressure of at least 55 bar.

13. The method as claimed in claim 6, wherein, for the preparation of the supercritical drying, water is replaced by an organic solvent.

14. The method as claimed in claim 13, wherein the organic solvent is acetone.
